(19) United States
(12) Patent Application Publication
(10) Pub. No.: US 2009/0313700 A1
(43) Pub. Date: Dec. 17, 2009

(54) METHOD AND SYSTEM FOR GENERATING MALWARE DEFINITIONS USING A COMPARISON OF NORMALIZED ASSEMBLY CODE

(76) Inventor: Jefferson Horne, Erie, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/137,230

(22) Filed: Jun. 11, 2008

(51) Int. Cl. G06F 12/14; G06F 17/30

(52) U.S. Cl. 726/24; 707/101; 707/E17.044

(57) ABSTRACT

A system and method for generating malware definitions for use in managing malware on a computer is described. One embodiment comprises receipt of a binary file running in system memory; taking a memory dump of the binary file at a time slice and storing the memory dump in a memory dump file; applying a normalization process to the memory dump file, wherein the normalization process alters a collection of data from the memory dump file, resulting in a normalized file; applying a comparison process between the normalized file and each of a plurality of normalized files stored in a database of malware definitions wherein the comparison process produces a comparison value associated with each of the normalized files in the database of malware definitions; and inserting the normalized file into the database of malware definitions, when each of the comparison values satisfies a predetermined criterion.

### FIELD OF THE INVENTION

The present invention relates to managing malware. In particular, but not by way of limitation, the present invention relates to systems and methods for generating malware definitions for use in managing malware on a computer by using a comparison of normalized assembly code.

### BACKGROUND OF THE INVENTION

Personal computers and business computers are continually attacked by trojans, spyware, and adware, collectively referred to as “malware.” These types of programs generally act to gather information about a person or organization, often without the person or organization's knowledge. Some malware is highly malicious. Other malware is non-malicious but may cause issues with privacy or system performance.

Software is presently available to detect and remove certain forms of malware. But as it evolves, the software to detect and remove it must also evolve. Accordingly, current techniques and software for removing malware are not always satisfactory and will most certainly not be satisfactory in the future. Current malware removal software uses definitions of known malware to search for and remove files on a protected system. These definitions are often outdated due to the constant creation of malware by virus writers. Further, malware can come in the form of child variations of a parent malware definition. Therefore, a piece of malware code may come in the form of new variations which existing definitions are unable to detect.

Additionally, malware is now being created with Polymorphic and Metamorphic code, potentially causing existing methods for malware detections insufficient. In computer malware terminology, Polymorphic code is computer code that mutates while keeping the original algorithm intact. In other words, the syntax of the code may continually change, however, the underlying functionality does not change. Additionally, Polymorphic code may place the majority of the functionality into encrypted code, while leaving a small unencrypted piece to jumpstart the encrypted portion. In contrast, Metamorphic code continually mutates itself, while maintaining the same functionality. Hence, recompiling and executing the binary of the Metamorphic code will result in the same functionality. However, the underlying code will have changed. This can be done by inserting null operation procedure (“NOP”), swapping registers, changing flow control with jumps or reordering independent instructions. The main difference between the two code types is that Polymorphic code ciphers its original code to avoid pattern recognition, whereas Metamorphic code actually changes its code to an a functionally equivalent version.

Although present methods as described above are functional, they may not be sufficiently accurate or otherwise satisfactory as present anti-virus detection and removal algorithms are constantly playing catch-up with Polymorphic and Metamorphic malware. Traditional anti-virus detection and removal algorithms use generic signature files for detecting known malware binaries. This is due to assumptions being made that the underlying malware code remains static. Further, traditional anti-virus detection algorithms often use wildcards in signature files in order to remain generic. In some instances, generic signature files may be adequate for detection of mutating malware. However, the constantly mutating characteristic of Polymorphic and Metamorphic coded malware makes it difficult for these traditional anti-virus removal algorithms to remove the malware properly or in its entirety. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a method and system for generating malware definitions for use in managing malware on a computer. One illustrative embodiment is a method, comprising receipt of a binary file running in system memory; taking a memory dump of the binary file at a time slice and storing the memory dump in a memory dump file; applying a normalization process to the memory dump file, wherein the normalization process alters a collection of data from the memory dump file, resulting in a normalized file; applying a comparison process between the normalized file and each of a plurality of normalized files stored in a database of malware definitions wherein the comparison process produces a comparison value associated with each of the normalized files in the database of malware definitions; and inserting the normalized file into the database of malware definitions, when each of the comparison values satisfies a predetermined criterion.

Further, an additional method for generating malware definitions for use in managing malware on a computer comprises the steps of receiving a binary file, wherein the binary file is running in a system memory; taking a first memory dump of the binary file at a first time slice and storing the first memory dump in a first memory dump file; taking a second memory dump of the binary file at a second time slice and storing the second memory dump in a second memory dump file; applying at least one normalization process against the first memory dump file, wherein the at least one normalization process at least one of alters and removes a first amount of data from the first memory dump file, resulting in a first normalized file; applying the least one normalization process against the second memory dump file, wherein the at least one normalization process at least one of alters and removes a second amount of data from the second memory dump file, resulting in a second normalized file; applying a first comparison process between the first normalized file and the second normalized file, wherein the first comparison process produces a comparison value between the first normalized file and the second normalized file; creating a second normalization process based on the comparison value between the first and second normalized files; applying the second normalization process against the first normalized file, wherein the second normalization process at least one of alters and removes a third amount of data from the first normalized file; applying the second normalization process against the second normalized file, wherein the second normalization process at least one of alters and removes a fourth amount of data from the second normalized file; applying a second comparison process between the first normalized file and each of a plurality of normalized files stored in the database of malware definitions, wherein the second differential process produces a first comparison value for each of the normalized files in the database of malware definitions; applying the second comparison process between the second normalized file and the plurality of normalized files stored in the database of malware definitions, wherein the second comparison process produces a second comparison value for each of the normalized files in the database of malware definitions; inserting the first normalized file into the database of malware definitions when each of the first comparison values satisfies a predetermined criterion; and inserting the second normalized file into the database of malware definitions when each of the second comparison values satisfies the predetermined criterion.

Another illustrative embodiment is a system for generating malware definitions for use in managing malware on a computer comprising at least one processor and a memory containing a plurality of program instructions configured to cause the at least one processor to receive a binary file, wherein the binary file is running in a system memory; take a first memory dump of the binary file at a first time slice and store the first memory dump in a first memory dump file; take a second memory dump of the binary file at a second time slice and store the second memory dump in a second memory dump file; apply at least one normalization process against the first memory dump file, wherein the at least one normalization process at least one of alters and removes a first amount of data from the first memory dump file, resulting in a first normalized file; apply the least one normalization process against the second memory dump file, wherein the at least one normalization process at least one of alters and removes a second amount of data from the second memory dump file, resulting in a second normalized file; apply a first comparison process between the first normalized file and the second normalized file, wherein the first comparison process produces a comparison value between the first normalized file and the second normalized file; create a second normalization process based on the comparison value between the first and second normalized files; apply the second normalization process against the first normalized file, wherein the second normalization process at least one of alters and removes a third amount of data from the first normalized file; apply the second normalization process against the second normalized file, wherein the second normalization process at least one of alters and removes a fourth amount of data from the second normalized file; apply a second comparison process between the first normalized file and each of a plurality of normalized files stored in the database of malware definitions, wherein the second differential process produces a first comparison value for each of the normalized files in the database of malware definitions; apply the second comparison process between the second normalized file and the plurality of normalized files stored in the database of malware definitions, wherein the second comparison process produces a second comparison value for each of the normalized files in the database of malware definitions; insert the first normalized file into the database of malware definitions when each of the first comparison values satisfies a predetermined criterion; and insert the second normalized file into the database of malware definitions when each of the second comparison values satisfies the predetermined criterion.

The invention may also be embodied at least in part as program instructions stored on a computer-readable storage medium, the program instructions causing a processor to carry out the methods of the invention.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a functional block diagram of a computer equipped with a malware detection application in accordance with an illustrative embodiment of the invention;

FIG. 2A-2B is a flowchart of a method for detecting malware in a binary file in accordance with an illustrative embodiment of the invention;

FIG. 3A-3B is a flowchart of a method for detecting malware in a binary file in accordance with another illustrative embodiment of the invention;

FIG. 4 is a flowchart of a method for preparing a binary file for application of differentiation techniques in accordance with another illustrative embodiment of the invention;

FIG. 5A is a diagram of a segment of assembly level instructions from a binary file; and

FIG. 5B is a diagram of a segment of assembly level instructions after it has been normalized.

### DETAILED DESCRIPTION

In various illustrative embodiments of the invention, the problem of detecting Polymorphic and Metamorphic code in malware is reduced by comparing variations of normalized assembly code from different memory dumps. The syntax of malware algorithms containing Polymorphic and Metamorphic code often change over time. Therefore, taking a memory dump of a malware executable at different time intervals may assist in malware detection by comparing the portions of assembly code that have changed between each memory dump.

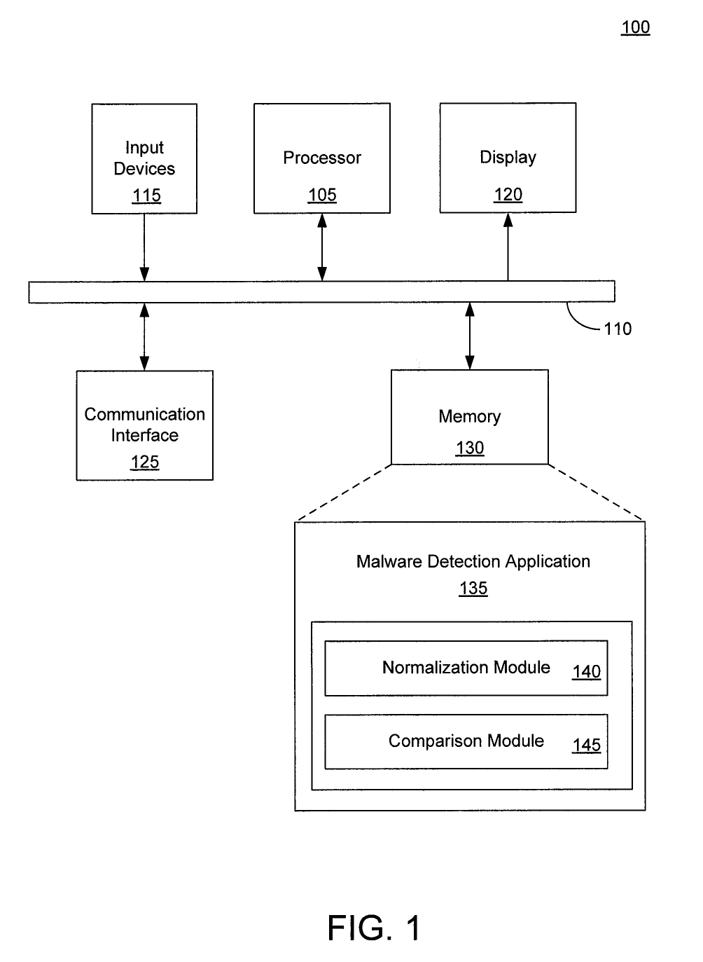

Referring now to the drawings, where like or similar elements are designated with identical reference numerals throughout the several views, and referring in particular to FIG. 1, it is a functional block diagram of a computer 100 equipped with a malware detection application 135 in accordance with an illustrative embodiment of the invention. Computer 100 may be any computing device capable of running a malware detection application 135. For example, computer 100 may be, without limitation, a personal computer (“PC”), a server, a workstation, a laptop computer, or a notebook computer.

In FIG. 1, processor 105 communicates over data bus 110 with input devices 115, display 120, communication interface 125, and memory 130. Though FIG. 1 shows only a single processor, multiple processors or multi-core processors may also be used.

Input devices 115 may include, for example, a keyboard, a mouse or other pointing device, or other devices that are used to input data or commands to computer 100 to control its operation.

In the illustrative embodiment shown in FIG. 1, communication interface 125 is a Network Interface Card (“NIC”) that implements a standard such as IEEE 802.3 (often referred to as “Ethernet”) or IEEE 802.11 (a set of wireless standards). In general, communication interface 125 permits computer 100 to communicate with other computers via one or more networks.

Memory 130 may include, without limitation, random access memory (“RAM”), read-only memory (“ROM”), flash memory, magnetic storage (e.g., a hard disk drive), optical storage, or a combination of these, depending on the particular embodiment. In FIG. 1, memory 130 includes malware detection application 135. Herein, the malware detection application refers to a computer application or automated script that receives a binary file suspected of containing malware, alters a copy of the binary file, and compares the binary file against other known binary files containing malware.

Throughout this application, binary files are discussed as being the target of malware attacks. Persons skilled in the art can appreciate that other file types can be infected by malware including text and graphic files to name a few. Therefore, the use of the binary file type throughout this application is meant as an example file type and not exclusive in scope.

In the illustrative embodiment of FIG. 1, malware detection application 135 includes a normalization module 140 and a comparison module 145. The division of malware detection application 135 into the particular functional modules shown in FIG. 1 is merely illustrative. In other embodiments, the functionality of these modules may be subdivided or combined in ways other than that indicated in FIG. 1, and the names of the various functional modules may also differ in other embodiments.

In one illustrative embodiment, malware detection application 135 and its functional modules shown in FIG. 1 are implemented as software that is executed by processor 105. Such software may be stored, prior to its being loaded into RAM for execution by processor 105, on any suitable computer-readable storage medium such as a hard disk drive, an optical disk, or a flash memory. In general, the functionality of malware detection application 135 may be implemented as software, firmware, hardware, or any combination or sub-combination thereof.

In one embodiment, normalization module 140 is used to normalize one or more binary files suspected of containing malware code. The functionality of a normalization process, in accordance with an embodiment of the invention, is to remove all irrelevant code from a memory dump file that does not contribute to the core functionality of the malware code. In other words, a binary file containing malware may comprise additional code which has little or no value to the underlying functionality. But, rather, this code is inserted to mask the functional code from detection. In an example relating to assembly language, this code my comprise an NOP, an addition of 1 to a register and then a subtraction of one from the same register, a jump call to a specific memory address, etc. In these examples, the code serves no functional purpose to the malware.

Returning to FIG. 1, normalization module 140 may access a data storage containing one or more normalization processes or techniques. Such a data storage may contain executable program code or uncompiled data. Once a binary file has been received, normalization module 140 may retrieve a normalization process from the data storage and execute the process against the binary file. In one embodiment, the normalization process may remove or alter segments of the code of the binary file. These code segments are often regarded as frivolous or are used by the creator of the malware binary to hide the underlying functionality of the malware binary.

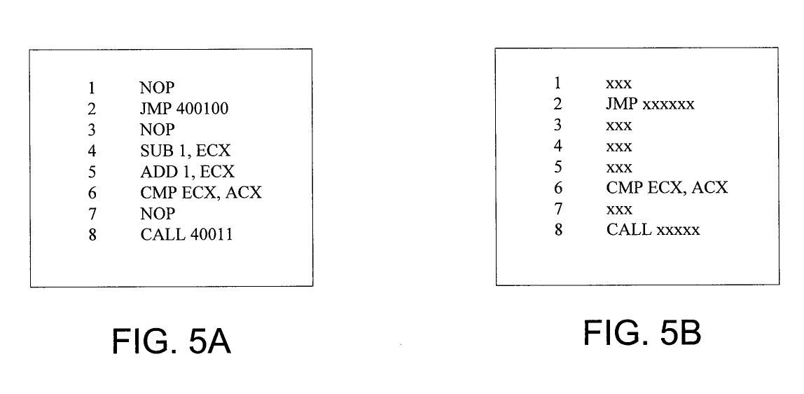

As known by those skilled in the art, many techniques may be used to normalize a binary file. This invention does not attempt to describe all such techniques of normalization. One such technique is described below in regards to FIGS. 5A and 5B. However, the technique described below is one example and not meant as being exclusive.

Comparison module 145 may be used to compare a binary file that is suspected of containing malware against one or more other binary files known to contain malware. In another embodiment, comparison module 145 may be used to compare a single binary file who's code has been dumped at two or more time slices. For example, a binary file containing Polymorphic and/or Metamorphic code is capable of altering the file's code over time. Thus, it may be useful to take multiple memory dumps of a single binary file at different time slices to see how the underlying code has changed between each memory dump.

As understood by those skilled in the art, many techniques may be used to compare a two or more binary files against each other. This invention does not attempt to describe all such techniques. However, some differential or comparison techniques that have been utilized include Bayesian and cosine differential functions.

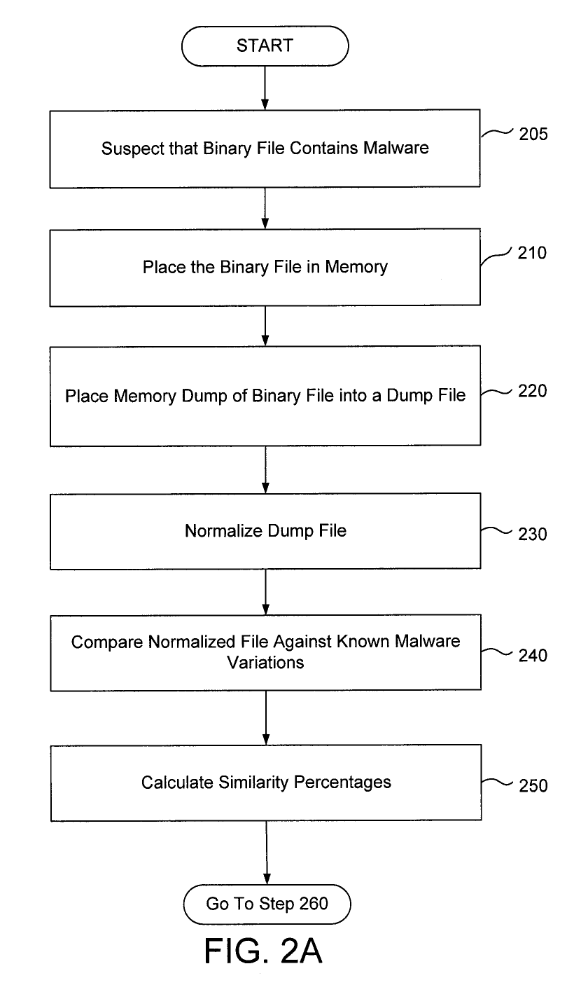

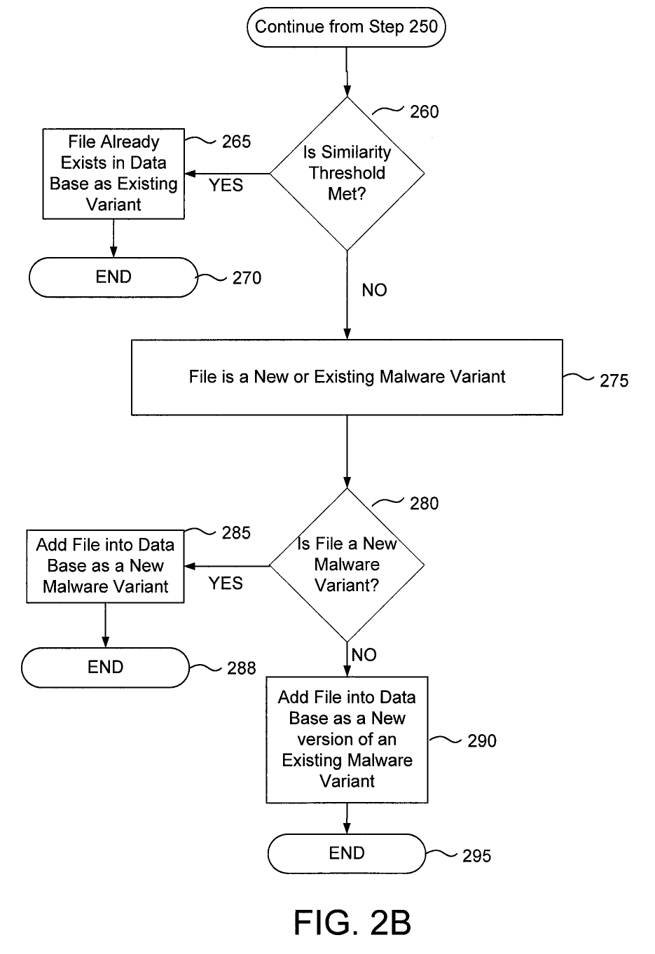

FIG. 2A is a flowchart of a method for detecting malware in a binary file in accordance with an illustrative embodiment of the invention. First, a binary file suspected of containing malware code is received (step 205). Upon receipt of the binary file, the file is placed in memory 130 of computer 100 (step 210). In one embodiment, placing the binary file in memory may be accomplished by executing the binary file within computer 100. Once the binary file is loaded into memory, a memory dump may be taken with the contents of the dump placed in a new file (step 220). This memory dump displays the code of the binary file at a given time slice. In one embodiment, the contents of the memory dump is in the form of assembly language. Assembly language is a low-level programming language implemented as a symbolic representation of the numeric machine codes and other constants needed to program a particular CPU architecture. A common such language is x86 assembly language, which is the assembly language for common INTEL 80x86™ microprocessors.

Once the memory dump is placed in a file (i.e., the “dump file”), the dump file is normalized by normalization module 140 (step 230). In one embodiment, the normalization process used may be customized for a specific binary file type, CPU architecture or other criteria. In another embodiment, the normalization process may not be binary specific, but rather used for multiple binary files suspected of containing malware.

FIG. 5A and 5B illustrate an example of a code segment before and after normalization. Specifically, FIG. 5A shows a code segment containing irrelevant code added to mask the core functionality of malware. In FIG. 5A, lines 1, 3-5, and 7 are irrelevant code used to mask the relevant code. For example, NOP commands provide no functionality to the assembly language code. Additionally, line 4 subtracts a value of 1 to a register ECX, followed by an addition of 1 to the same register. Again, this code provides no functional value. A normalization process may be programmed to know this and automatically strip out such lines. This can be seen in FIG. 5B as a string of x's. In another embodiment, the value of functional lines of code may also be irrelevant. In other words, the relevant portion of the line of code is the function it provides, not its value. For example, line 2 jumps to a specific memory address value of 400100. This memory address value may not be relevant and hence stripped out by the normalization process. This can be shown in FIG. 5B. Once all the irrelevant code has been removed from or altered in FIG. SA, the resulting code of FIG. 5B represents three lines of code with values having been removed in two of the lines. Such an example is scaled back to simplify the explanation. Actual malware programs may contain thousands of lines of code with even more lines of code being used to mask the underlying functionality of the malware.

Returning to FIG. 2A, once the dump file has been normalized, the remaining code (i.e., the normalized code) may be placed in an additional file. Next, the normalized code is compared with one or more known malware variations (step 240) by the comparison module 145. A malware variation is a variation of a known malware algorithm. Typically, each malware algorithm is given a name to identify it. Variations of malware may exist where the functionality remains substantially the same, but the actual code or method for performing the function may differ. It is possible for a single malware algorithm to have hundreds of variations, wherein each one differs slightly from the parent, yet they are classified as the same algorithm.

Typically these malware variations are stored in a database. In one embodiment, such a database may comprise all known malware variations. In another embodiment, the database may be local in nature and comprise a portion of the known malware variations.

In one embodiment, comparison module 145 compares the normalized file against each of the malware variations stored in the database. This comparison may be done sequentially, in parallel or some variation of the two. A comparison between two files may be a comparison of both the functionality and the syntax used. In one embodiment, the end result of a comparison may be a similarity percentage.

Many types of differential processes or techniques may be used to compare two files. In one embodiment a Bayesian differential process may be used. In another embodiment, a cosine differential process may be used. Additionally, custom or hybrid differential processes may be used without limiting the scope of the invention. In another embodiment, the comparison process used to compare the normalized code against the known malware variations may be altered. Such alterations may be based on comparison values (described in step 250) generated by the comparison process. In one embodiment, proposed alterations to the comparison process are indirectly revealed from one or more of the comparison values obtained in the comparisons between the normalization file and the malware variations.

Once each known malware variation is compared to the normalized file, the resulting similarity percentages are calculated (step 250). For example, a comparison between the normalized file and variation B of the Anthrax virus may result in a 43% similarity. In one embodiment, this may mean that 43% of the lines of code between each file are the same and in the same order. In another embodiment, the ordering of the lines may be completely different, however, 43% of the lines may be the same. In yet another embodiment, the comparison process may be customized to place different weights on different code segments. For example, the overall line by line similarity between two files may be low, but a certain segment of code my be identical. As a result, the overall similarity percentage may be higher than if all code segments were weighted the same.

Once similarity percentages are calculated between the normalized file and each malware variation, each similarity percentage is compared against a similarity threshold (step 260). In one embodiment, this threshold may be a specific percentage. For example, if the threshold is 50% and the similarity percentage is 49%, the threshold is not met. In another embodiment the similarity threshold may include many factors in which similarity percentage is only one factor. Computer 100 may be responsible for analyzing whether the similarity between two binary files exceeds the similarity threshold. In another embodiment, this determination may be done manually by a human user observing the data on a case by case basis.

If the similarity threshold between the normalized file and one of the malware variations is met, the normalized file is not added to the database as a new variation (step 265) and the process terminates (step 270). The normalized file is not added to the malware database since a close enough (or exact) equivalent already exists such that adding the normalized file to the malware database may be redundant.

On the other hand, if none of the similarity percentages between the normalized file and the malware variations meets the similarity threshold, the binary file corresponding to the normalized file may be a new variety of malware or a variation of an existing variety of malware (step 275). Next, an additional determination is made as to whether the normalized file should be added to the malware database as a new variation to an existing malware algorithm or a new version of an existing variation of a known variety of malware having a pre-determined threshold difference between other files labeled under the same variation (step 280). In regards to a new version of an existing variant, variant B of the Anthrax virus may have multiple versions with minor differences amongst them. These differences may not be enough for them to become new variants, yet they may be dissimilar enough to be differing versions of the same existing variant.

In one embodiment, the determination discussed in step 280 may be based on the similarity percentage calculated in step 250 above. For example, if the similarity threshold was 50%, the threshold for being a new variation may be 25%. Therefore, if the calculated similarity percentage between the normalized file and variant B of the Anthrax virus is 40%, it would be low enough to be either a new variant or a new version of an existing variation having an acceptable difference between other files labeled under the same variant. With the threshold being 25%, the binary would not be a new variant because its similarity percentage is 40%. Hence, the file would be added to the malware database as a new version of an existing variant (step 290) followed by the method ending (step 295). On the other hand, if the threshold for being a new variant were 42% instead of the 25% shown above, the normalized file would in fact be a new variant and added to the database as such (step 285). Lastly, the method ends (step 288).

The method described in regards to FIG. 2 is merely an example. The use of similarity thresholds are but one embodiment for determining whether a normalized binary file is considered a new malware variation. In another embodiment, human operators may be involved at least in part in determining whether a binary file may be categorized as a malware variant. A human operator may know that certain similarities between a normalized binary file and a malware variant are sufficient in and of themselves to warrant categorizing the binary file as a malware variant, regardless of the percentage of similarity between them. For example, a human operator might know that if 15 particular lines of a normalized binary file made up of 1000 lines of code are identical to 15 corresponding lines of the malware variant, the binary file is likely a malware variant despite the overall percentage similarity being low. Persons skilled in the art can appreciate that other methods for categorizing a binary file as a malware variant may exist. In other words, tests that meet one or more sufficient conditions may be adequate in categorizing a binary file as a malware variant. In some embodiments, such sufficient-conditions tests can override any determination made based on similarity scores such as similarity percentages. These heuristic tests based on sufficient conditions are automated in some embodiments and performed at least in part by a human operator in other embodiments.

In another embodiment regarding FIGS. 2A and 2B, step 250 may be used to determine a dissimilarity percentage in contrast to a similarity percentage. In other words, a comparison between the normalized file and variation B of the Anthrax virus may result in a 57% dissimilarity. In one embodiment, this may mean that 57% of the lines of code between each file are different or in a different order. In another embodiment, the comparison process may be customized to place different weights on different code segments. As a result, the overall dissimilarity percentage may be lower than if all code segments were weighted the same.

In yet another embodiment regarding FIGS. 2A and 2B, step 260 may associate with a dissimilarity threshold instead of a similarity threshold. For instance, if the dissimilarity threshold is 50% and the dissimilarity percentage between the normalized file and variant B of the Anthrax virus is 57%, the normalized file may be added to the database.

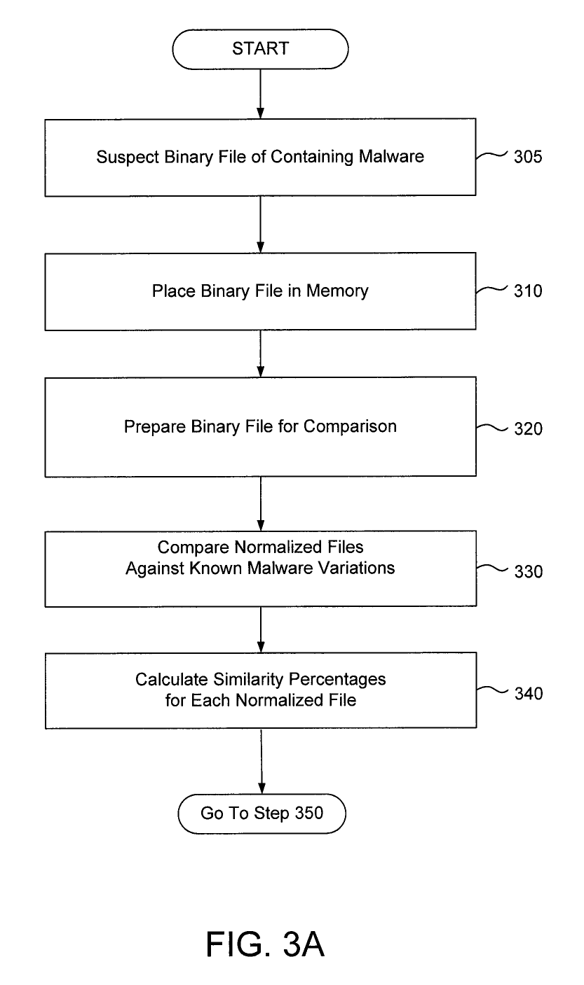

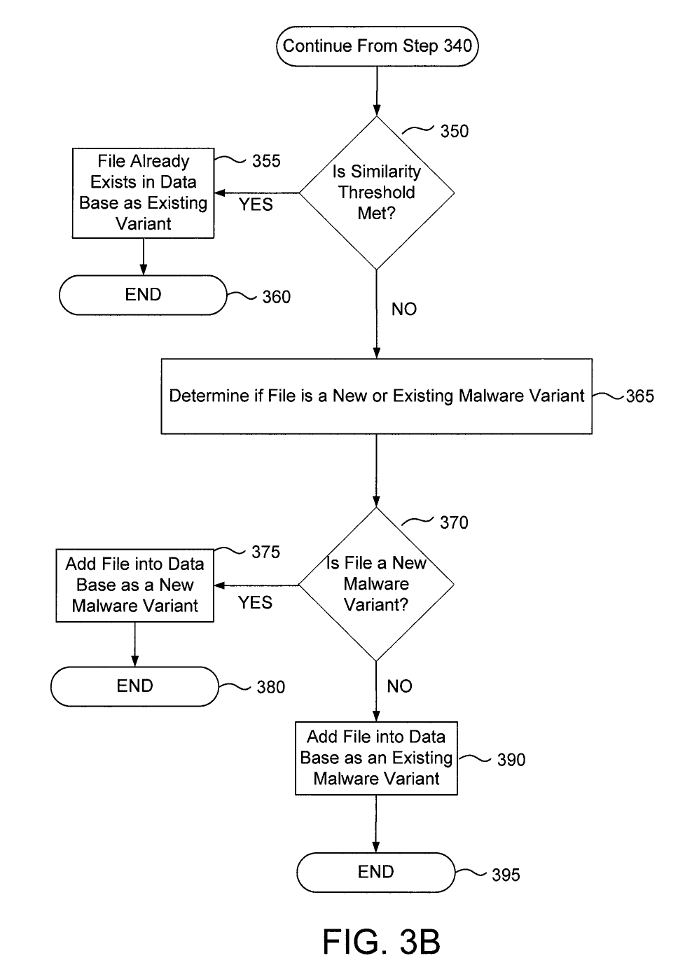

The flow chart illustrated by FIGS. 2A and 2B are used for binary files that traditionally do not comprise Polymorphic or Metamorphic code. However, the method illustrated in FIGS. 2A and 2B may still be used if the binary file contains Polymorphic or Metamorphic code. On the other hand, a different approach may be utilized to determine the existence of malware in a binary file if the binary file comprises Polymorphic or Metamorphic code. Hence, FIG. 3A is a flowchart of an additional method for detecting malware in a binary file having Polymorphic or Metamorphic code, in accordance with an illustrative embodiment of the invention.

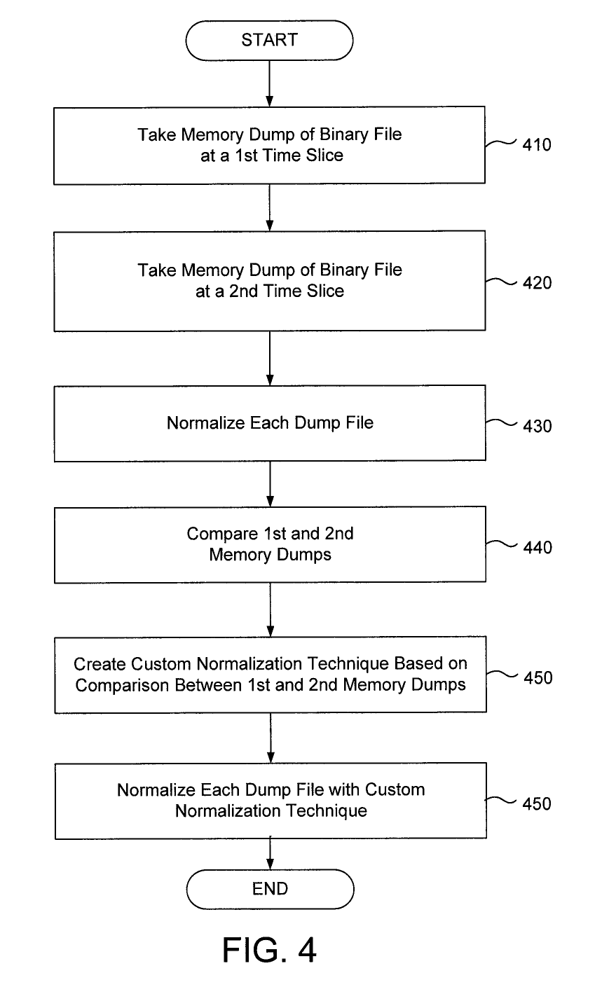

First, a binary file suspected of containing malware code is received (step 305). Upon receipt of the binary file, it is placed in memory 130 of computer 100 (step 310). In one embodiment, placing the binary file in memory may be accomplished by executing the binary file within computer 100. Next, the binary file is prepared for comparison (step 320) between other files stored in a malware database. FIG. 4 further describes the steps used to prepare the binary file for comparison. From step 320, two normalized files are created out of the original binary file.

Comparison module 145 is responsible for differentiating the two normalized files between one or more known malware variations stored in the malware database (step 330). In one embodiment, normalization module 145 compares the normalized files against each of the malware variations stored in the malware database. This comparison may be done sequentially, in parallel or some variation of the two. A comparison between two files may be a comparison of both the functionality and the syntax used. In one embodiment, the end result of a comparison may be a similarity percentage.

As previously stated, many types of differential processes or techniques may be used to compare two files. In one embodiment a Bayesian differential process may be used. In another embodiment, a cosine differential process may be used. Additionally, custom or hybrid differential processes may be used without limiting the scope of the invention.

Once the known malware variations, stored in the malware database, are compared against the normalized files, the resulting similarity percentages are calculated (step 340). As previously described in regards to FIGS. 2A and 2B, a similarity percentage may be a culmination of differing weights placed on different code segments. For example, the overall line by line similarity between two files may be low, but a certain segment of code my be identical. As a result, the overall similarity percentage may be higher than if all code segments were weighted the same.

In another embodiment to step 340, dissimilarity percentages may be used in place of similarity percentages. As described above in regards to step 250 a comparison of code segments between the normalized file and an existing malware variant may result in a percentage of dissimilarity between the two files in contrast to a similarity.

Once similarity percentages are calculated between the normalized files and each malware variation, each similarity percentage is compared against a similarity threshold (step 350). As with step 260 in FIG. 2B the threshold may be a specific percentage or the similarity threshold may include many factors in which similarity percentage is only one factor. Computer 100 may be responsible for analyzing whether the similarity between two binary files pass the similarity threshold. In another embodiment, this determination may be done by a human user in a case by case basis.

In yet another embodiment, step 350 may be based on a dissimilarity threshold as described above in regards to step 260. In other words, the percentage that the normalized file and an existing malware variant are dissimilar from each other may be used in contrast to them being similar.

If the similarity threshold between the normalized file and one of the malware variations are met, the normalized file is not added to the database as a new variation (step 355) and the execution of malware detection application 135 ends (step 360). The normalized file is not added to the malware database since a close enough (or exact) equivalent already exists such that adding the normalized file to the malware database would be redundant.

Alternatively, if the similarity threshold between the normalized files and one of the malware variations are not met, there may be the creation of an existing malware variation having a new version or a new malware variation of an existing virus (step 365). Next, an additional determination is made as to whether the normalized file should be added to the malware database as a new variation to an existing virus or a new version of an existing variation having an acceptable difference between other files labeled under the same variation (step 370).

In one embodiment, the determination discussed in step 370 may be based on the similarity percentage calculated in step 340 above. For example, if the similarity threshold was 50%, the threshold for being a new variation may be 25%. Therefore, if the calculated similarity percentage between the normalized file and variant B of the Anthrax virus is 40%, it would be low enough to be either a new variant or a new version of an existing variation having an acceptable difference between other files labeled under the same variant. With the threshold being 25%, the binary would not be a new variant because its similarity percentage is 40%. Hence, the file would be added to the malware database as a new version of an existing variant (step 390) followed by the method ending (step 395). On the other hand, if the threshold for being a new variant were 42% instead of the 25% shown above, the normalized file would in fact be a new variant and added to the database as such (step 375). Lastly, the method ends (step 380).

As previously stated, the use of a similarity threshold in determining whether a binary file is considered a new malware variant is only one embodiment of how such a determination may be made. In another embodiments, a human operator may be involved at least in part in determining whether a binary file is considered a malware variant. Further, any tests based on the satisfaction of one or more sufficient conditions may be adequate in categorizing a binary file as a malware variant, as discussed above.

As previously stated, step 320 prepares the binary file for comparison. FIG. 4 is a flow chart describing the steps for preparing a binary file for comparison, in accordance with an illustrative embodiment of the invention. As described in FIG. 2A a memory dump was taken of the binary file suspected of containing malware code. Further, the dump file was normalized to remove irrelevant information. A similar process is followed in FIG. 4, however, the inclusion of Polymorphic or Metamorphic code adds some additional steps.

To begin the preparation of the binary file for comparison, a first memory dump is taken of the binary file at a first time slice (step 410). Next, a second memory dump is taken of the binary file at a second time slice (step 420). The time difference between the two steps may vary from a few milliseconds to substantially longer. A binary file containing Polymorphic or Metamorphic code may result in the underlying assembly language code changing over time. By taking two or more memory dumps of the binary file at different times, it is possible to see what portions of code have changed. These changes may indicate which portions of code are Polymorphic or Metamorphic code.

Once the two memory dumps are taken, each dump is normalized (step 430) by the normalization module 140. The process of normalization may be similar to the process used in step 230 above. As previously stated, the normalization process used may be customized for a specific binary file type, CPU architecture, or other criteria. In another embodiment, the normalization process may not be specific, but rather used for multiple binary files suspected of containing malware. In one embodiment, the two memory dump files may be normalized in parallel, serially, or some combination of the two.

Once the two dump files have been normalized, the resulting code of each file may be placed in new files (i.e., normalized files). The normalized files are then compared against each other (step 440) by the comparison module 145. In one embodiment, a similarity percentage is computed from the outcome of the comparison. In another embodiment, additional information may be generated from the comparison process. As with FIG. 2A and 3A the comparison process may be a Bayesian differential process, a cosine differential process, or any other customized differential process.

Based on the output of the comparison process, a custom normalization routine may be created (step 450). This custom normalization routine uses information from the comparison output to better tailor normalization procedures to the specific memory dumps. Since the original binary file contained Polymorphic or Metamorphic code, a standard normalization procedure may be less than optimal in removing irrelevant information. Once a comparison between the two memory dumps of the binary file has been executed, this additional knowledge permits for a customized normalization procedure to be used. For example, units of code (e.g., bytes) without a functional use may be interspersed throughout the file. A standard normalization routine may be ill-equipped to remove this code. However, once a comparison has been performed, the normalization routine may be altered to account for and remove the interspersed code. In one embodiment, proposed alterations to the normalization routine are indirectly revealed from the information obtained in the comparison between the two memory dumps of the binary file. In one embodiment, the customized normalization routine is created by the normalization module 140. In another embodiment, the customized normalization routine is created by a human operator on a case by case basis.

Once the custom normalization routine is created, the two memory dump files are re-normalized (step 460). The memory dump files may have additional irrelevant information removed, making the subsequent comparison from step 330 increasingly efficient in matching similarities between the two files.

In conclusion, the present invention provides, among other things, a system and method for detecting malware code within a binary file. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A method for generating malware definitions for use in managing malware on a computer, the method comprising:
receiving a binary file, the binary file running in a system memory;
taking a first memory dump of the binary file at a first time slice and storing the first memory dump in a first memory dump file;
applying a first normalization process to the first memory dump file, wherein the first normalization process at least one of removes and alters a first collection of data from the first memory dump file, resulting in a first normalized file;
applying a first comparison process between the first normalized file and each of a plurality of normalized files stored in a database of malware definitions, wherein the first comparison process produces a comparison value associated with each of the normalized files in the database of malware definitions; and
inserting the first normalized file into the database of malware definitions, when each of the comparison values satisfies a predetermined criterion.

2. The method of claim 1, further comprising:
flagging the first normalized file as already existing in the database of malware definitions, when at least one of the comparison values fails to satisfy the predetermined criterion.

3. The method of claim 1, further comprising:
applying a second normalization process against the first memory dump file, wherein the second normalization process at least one of alters and removes a second collection of data from the first memory dump file and wherein the second normalization process executes substantially concurrently with the first normalization process.

4. The method of claim 1, wherein inserting the first normalized file into the database of malware definitions further comprises:
flagging the first normalized file as an existing malware variant when at least one of the comparison values fails to satisfy a predetermined variant criterion; and
flagging the first normalized file as a new malware variant when all of the comparison values fail to satisfy the predetermined variant criterion.

5. The method of claim 4, wherein the predetermined variant criterion is that the comparison value falls below a predetermined variant similarity threshold.

6. The method of claim 1 further comprising:
altering the first normalization process based on the first collection of data at least one of altered and removed from the first memory dump file, wherein the first collection of data indicates that one or more bytes of code are repetitively inserted throughout the binary file, the first collection of data indirectly revealing an alteration to the first normalization process.

7. The method of claim 6 further comprising:
altering the first comparison process based on the comparison values between the first normalized file and each of the plurality of normalized files in the database of malware definitions, wherein at least one of the comparison values indicate that one or more bytes of code are repetitively inserted throughout the first normalized file, the at least one of the comparison files indirectly revealing an alteration to the first comparison process.

8. The method of claim 1, wherein the first differential process is one of a cosine differential process and a Bayesian differential process.

9. The method of claim 1, further comprising:
altering a malware signature file when the first normalized file is inserted into the database of malware definitions.

10. The method of claim 1, wherein the predetermined criterion is that the comparison value falls below a predetermined similarity threshold.

11. The method of claim 1, further comprising:
inserting the first normalized file into the database of malware definitions, when the first normalized file satisfies a sufficient-condition test regardless of whether each of the comparison values satisfies the predetermined criterion.

12. A method for generating malware definitions for use in managing malware on a computer, comprising:
receiving a binary file, wherein the binary file is running in a system memory;
taking a first memory dump of the binary file at a first time slice and storing the first memory dump in a first memory dump file;
taking a second memory dump of the binary file at a second time slice and storing the second memory dump in a second memory dump file;
applying at least one normalization process against the first memory dump file, wherein the at least one normalization process at least one of alters and removes a first collection of data from the first memory dump file, resulting in a first normalized file;
applying the at least one normalization process against the second memory dump file, wherein the at least one normalization process at least one of alters and removes a second collection of data from the second memory dump file, resulting in a second normalized file;
applying a first comparison process between the first normalized file and the second normalized file, wherein the first comparison process produces a comparison value between the first normalized file and the second normalized file;
creating a second normalization process based on the comparison value between the first and second normalized files;
applying the second normalization process against the first normalized file, wherein the second normalization process at least one of alters and removes a third collection of data from the first normalized file;
applying the second normalization process against the second normalized file, wherein the second normalization process at least one of alters and removes a fourth collection of data from the second normalized file;
applying a second comparison process between the first normalized file and each of a plurality of normalized files stored in the database of malware definitions, wherein the second differential process produces a first comparison value for each of the normalized files in the database of malware definitions;
applying the second comparison process between the second normalized file and the plurality of normalized files stored in the database of malware definitions, wherein the second comparison process produces a second comparison value for each of the normalized files in the database of malware definitions;
inserting the first normalized file into the database of malware definitions when each of the first comparison values satisfies a predetermined criterion; and
inserting the second normalized file into the database of malware definitions when each of the second comparison values satisfies the predetermined criterion.

13. The method of claim 12, further comprising:
flagging the first normalized file as already existing in the database of malware definitions, when at least one of the first comparison values fails to satisfy the predetermined criterion; and
flagging the second normalized file as already existing in the database of malware definitions, when at least one of the second comparison values fails to satisfy the predetermined criterion.

14. The method of claim 12, wherein inserting the first normalized file into the database of malware definitions, comprises:
flagging the first normalized file as a first existing malware variant when at least one of the first comparison values fails to satisfy a predetermined variant criterion;
flagging the first normalized file as a first new malware variant when all of the first comparison values fail to satisfy the predetermined variant criterion;
flagging the second normalized file as a second existing malware variant when at least one of the second comparison values fails to satisfy the predetermined variant criterion; and
flagging the second normalized file as a second new malware variant when all of the second comparison values fail to satisfy the predetermined variant criterion.

15. The method of claim 14, wherein the predetermined variant criterion is that the comparison value falls below a predetermined variant similarity threshold.

16. The method of claim 12 further comprising:
altering the first comparison process based on the first collection of data at least one of altered and removed from the first memory dump file.

17. The method of claim 12 further comprising:
altering the first comparison process based on the comparison value between the first normalized file and the second normalized file.

18. The method of claim 17 further comprising:
altering the second comparison process based on the second comparison value between the first normalized file and each of the plurality of normalized files in the database of malware definitions; and
further altering the second comparison process based on the second comparison value between the second normalized file and each of the plurality of normalized files in the database of malware definitions.

19. The method of claim 12, wherein the first differential process and the second differential process are one of a cosine differential process and a Bayesian differential process.

20. The method of claim 12, further comprising:
altering a first malware signature file when the first normalized file is inserted into the database of malware definitions; and
altering a second malware signature file when the second normalized file is inserted into the database of malware definitions.

21. The method of claim 12, wherein the database of malware definitions is locally stored on a computer.

22. The method of claim 12, wherein the predetermined criterion is that the comparison value falls below a predetermined similarity threshold.

23. The method of claim 12, further comprising:
inserting the first normalized file into the database of malware definitions, when the first normalized file satisfies a first sufficient-condition test regardless of whether each of the first comparison values satisfies the predetermined criterion;
inserting the second normalized file into the database of malware definitions, when the second normalized file satisfies a second sufficient-condition test regardless of whether each of the second comparison values satisfies the predetermined criterion.

24. A computer-readable storage medium containing a plurality of program instructions executable by a processor for generating malware definitions for use in managing malware on a computer comprising:
a first instruction segment configured to receive a binary file, wherein the binary file is running in a system memory;
a second instruction segment configured to take a first memory dump of the binary file at a first time slice and storing the first memory dump in a first memory dump file;
a third instruction segment configured to apply a first normalization process to the first memory dump file, wherein the first normalization process at least one of removes and alters a first collection of data from the first memory dump file, resulting in a first normalized file;
a four instruction segment configured to apply a first comparison process between the first normalized file and each of a plurality of normalized files stored in a database of malware definitions wherein the first comparison process produces a comparison value associated with each of the normalized files in the database of malware definitions; and
a fifth instruction segment configured to insert the first normalized file into the database of malware definitions, when each of the comparison values satisfies a predetermined criterion.

25. A computer-readable storage medium containing a plurality of program instructions executable by a processor for generating malware definitions for use in managing malware on a computer comprising:
a first instruction segment configured to receive a binary file, wherein the binary file is running in a system memory;
a second instruction segment configured to take a first memory dump of the binary file at a first time slice and storing the first memory dump in a first memory dump file;
a third instruction segment configured to take a second memory dump of the binary file at a second time slice and storing the second memory dump in a second memory dump file;
a fourth instruction segment configured to apply at least one normalization process against the first memory dump file, wherein the at least one normalization process at least one of alters and removes a first collection of data from the first memory dump file, resulting in a first normalized file;
a fifth instruction segment configured to apply the least one normalization process against the second memory dump file, wherein the at least one normalization process at least one of alters and removes a second collection of data from the second memory dump file, resulting in a second normalized file;
a six instruction segment configured to apply a first comparison process between the first normalized file and the second normalized file, wherein the first comparison process produces a comparison value between the first normalized file and the second normalized file;
a seventh instruction segment configured to create a second normalization process based on the comparison value between the first and second normalized files;
an eighth instruction segment configured to apply the second normalization process against the first normalized file, wherein the second normalization process at least one of alters and removes a third collection of data from the first normalized file;
a ninth instruction segment configured to apply the second normalization process against the second normalized file, wherein the second normalization process at least one of alters and removes a fourth collection of data from the second normalized file;
a tenth instruction segment configured to apply a second comparison process between the first normalized file and each of a plurality of normalized files stored in the database of malware definitions, wherein the second differential process produces a first comparison value for each of the normalized files in the database of malware definitions;
an eleventh instruction segment configured to apply the second comparison process between the second normalized file and the plurality of normalized files stored in the database of malware definitions, wherein the second comparison process produces a second comparison value for each of the normalized files in the database of malware definitions;
a twelfth instruction segment configured to insert the first normalized file into the database of malware definitions when each of the first comparison values satisfies a predetermined criterion; and
a thirteenth instruction segment configured to insert the second normalized file into the database of malware definitions when each of the second comparison values satisfies the predetermined criterion.

26. A system for generating malware definitions for use in managing malware on a computer comprising:
at least one processor; and
a memory containing a plurality of program instructions configured to cause the at least one processor to:
receive a binary file, the binary file running in a system memory;
take a first memory dump of the binary file at a first time slice and storing the first memory dump in a first memory dump file;
apply a first normalization process to the first memory dump file, wherein the first normalization process at least one of removes and alters a first collection of data from the first memory dump file, resulting in a first normalized file;
apply first comparison process between the first normalized file and each of a plurality of normalized files stored in a database of malware definitions, wherein the first comparison process produces a comparison value associated with each of the normalized files in the database of malware definitions; and
insert the first normalized file into the database of malware definitions, when each of the comparison values satisfies a predetermined criterion.
